(19) United States
(12) Patent Application Publication
(10) Pub. No.: US 2010/0006508 A1
(43) Pub. Date: Jan. 14, 2010

(54) Multi-Stage Water Filters

(75) Inventors: Michael Donovan Mitchell, Cincinnati, OH (US); Gary Echler, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/498,626

(22) Filed: Jul. 7, 2009

Related U.S. Application Data
(60) Provisional application No. 61/079,323, filed on Jul. 9, 2008.
(60) Provisional application No. 61/158,547, filed on Mar. 9, 2009.

(51) Int. Cl. B01D 36/02; C02F 1/00; C02F 1/28; B01D 15/02; B01D 35/06

(52) U.S. Cl. 210/669; 210/263; 210/663; 210/252; 210/259

(57) ABSTRACT

Water filters and methods of filtering fluids (e.g., water) to produce treated water such as potable water. Specifically, water filters comprising activated carbon, fiber composites, or combinations thereof that are operable to remove heavy metals and/or viruses from fluids to produce potable water. The water filters may comprise at least one carbon filter comprising activated carbon particles, and at least one fiber composite filter comprising electropositive metallic fibers having dimensions of between 5 nm and 100 nm. The fiber composite filter may be disposed upstream of the carbon filter, downstream of the carbon filter, or both.

### CROSS REFERENCE TO RELATED APPLICATIONS

This application claims the benefit of U.S. Provisional Application Ser. No. 61/079,323 filed Jul. 9, 2008, and U.S. Provisional Application Ser. No. 61/158,547 filed Mar. 9, 2009. The aforementioned applications are incorporated herein by reference in their entirety.

### TECHNICAL FIELD

The present invention is generally directed to water filters and methods of producing potable water, and is specifically directed to multi-stage water filters comprising activated carbon filters, fiber composite filters, or combinations thereof that are operable to remove heavy metals and/or viruses to produce potable water.

### BACKGROUND

Fluid contaminants, particularly contaminants in water, may include various elements and compositions such as heavy metals (e.g., lead), microorganisms (e.g., bacteria, viruses), acids (e.g., humic acids), or any contaminants listed in NSF/ANSI Standard No. 53. As used herein, the terms “microorganism”, “microbiological organisms”, “microbial agent”, and “pathogen” are used interchangeably. These terms, as used herein, refer to various types of microorganisms that can be characterized as bacteria, viruses, parasites, protozoa, and germs. In a variety of circumstances, these contaminants, as set forth above, must be removed before the water can be used. For example, in many medical applications and in the manufacture of certain electronic components, extremely pure water is required. As a more common example, any harmful contaminants must be removed from the water before it is potable, i.e., fit to consume. While filtering is conducted in some industrial/municipal water treatment systems, these filters may not be suitable for and/or achieve the removal performance suitable or required for use in consumer-friendly water filtering applications, e.g. household and personal use filter applications, and/or to produce potable water. As a result, there is a continual need for filters with improved removal capability of contaminants.

### SUMMARY

According to one embodiment of the present invention, a water filter is provided. The water filter comprises at least one carbon filter comprising activated carbon particles, and at least one fiber composite filter comprising electropositive metallic fibers having dimensions of between 5 nm and 100 nm, wherein the fiber composite filter is disposed upstream of the carbon filter, downstream of the carbon filter, or both.

According to another embodiment, a water filter may comprise a first carbon filter comprising activated carbon particles, and a second carbon filter disposed upstream of the first carbon filter, downstream of the first carbon filter, or combinations thereof.

According to further embodiments, a method of producing potable water using the filters of the present invention is provided. These and additional objects and advantages provided by the embodiments of the present invention will be more fully understood in view of the following detailed description, in conjunction with the drawings.

### BRIEF DESCRIPTION OF THE DRAWINGS

The following detailed description of specific embodiments of the present invention can be best understood when read in conjunction with the drawings enclosed herewith.

FIG. 1 is a cross-sectional perspective view of an exemplary water filter comprising a fiber composite filter disk and a downstream carbon block filter according to one or more embodiments of the present invention;

FIG. 2 is a schematic view of an exemplary water filter comprising a carbon filter layer, a fiber composite filter layer, and a sediment wrap according to one or more embodiments of the present invention;

FIG. 3 is a cross-sectional view of an exemplary water filter comprising a carbon block filter and a pre-filter wrap around the carbon block filter according to one or more embodiments of the present invention;

FIG. 4 is a cross-sectional view of an exemplary water filter comprising a carbon bed filter and a downstream fiber composite filter according to one or more embodiments of the present invention;

FIG. 5 is a side view of an exemplary water filter mounted on a faucet according to one or more embodiments of the present invention;

FIG. 6 is a side view of an exemplary water filter mounted in a pitcher unit according to one or more embodiments of the present invention; and

FIG. 7 is a graphical illustration of the performance of a water filter as shown in FIG. 1 in comparison to a filter without an upstream fiber composite filter according to one or more embodiments of the present invention; and

FIG. 8 is a graphical illustration of the performance of a water filter with an upstream carbon filter in comparison to a filter without an upstream filter according to one or more embodiments of the present invention.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

According to one or more exemplary embodiments of the present invention, may comprise a carbon filter and optionally an additional filter disposed upstream of the carbon filter (hereinafter “pre-filter”), downstream of the carbon filter (hereinafter “post-filter”), or both. The carbon filter may comprise activated carbon particles, and the optional pre-filter or post-filter may each comprise an activated carbon filter, a fiber composite filter, or combinations thereof.

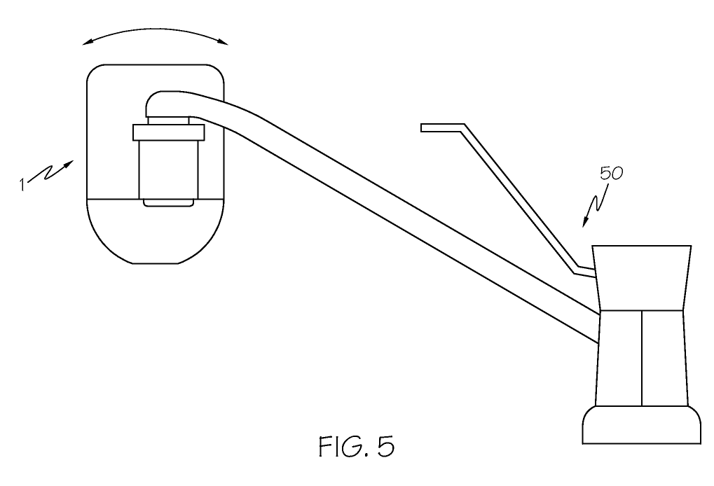

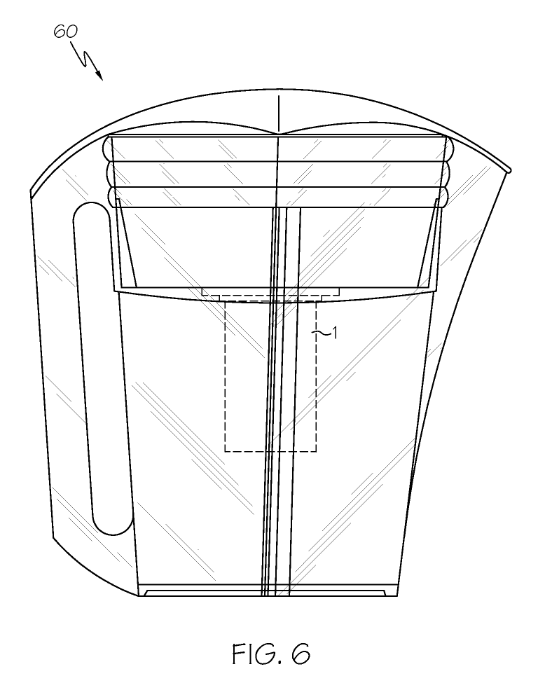

The activated carbon filters or fiber composite filters, which are described in detail below, are operable individually to remove contaminants such as heavy metals, humic acids, and/or microorganisms from fluids, or may be used in tandem to remove such contaminants more effectively and/or at an increased level. The water filters may be used in industrial and commercial applications as well as personal consumer applications, e.g., household and personal use applications. The water filter is operable to be used with various fixtures, appliances, or components familiar to one of skill in the art. For example, it can be used in a refrigerator for water filtering, or mounted inside a fluid pitcher as shown in FIG. 6. In yet another embodiment, the water filter may be faucet mounted as shown in FIG. 5.

While not being limited to these compositions, the carbon filters may comprise activated carbon particles, and may include various suitable compositions and structures. In one embodiment, the carbon filter 2 may be a filter block containing activated carbon particles or powders compressed into a block structure. As used herein, the phrase “filter block” is intended to refer to a mixture of filter particles bound together to form a structure that is capable of filtering a liquid, for example water, air, hydrocarbons, and the like. As such a filter block may comprise filter particles, binder particles, and other particles or fibers for the removal of specific contaminants, such as lead, mercury, arsenic, etc. A filter block can vary in geometry and flow patterns. One of many contemplated current filter block making processes is a single cavity compression molding process using ohmic heating.

Alternatively, the carbon filter may comprise of loose bed of carbon particles without a binder. Moreover, the filters of the present invention may also comprise other filter systems including reverse osmosis systems, ultra-violet light systems, ozone systems, ion exchange systems, electrolyzed water systems, and other water treatment systems known to those with skill in the art. Also, the filters of the present invention may comprise pre-filters wrapped around the filter blocks to prevent the filter blocks from clogging with suspended particles. Furthermore, the filters of the present invention may comprise indicator systems and/or shut-off systems to indicate to the consumer the remaining life/capacity of the filter and to shut-off the filter when the filter's remaining life/capacity is zero.

In accordance with a few exemplary embodiments, the activated carbon particles of the carbon filter may comprise carbons from a variety of sources, e.g., wood-based carbon, coconut carbon, or combinations thereof. Other sources, for example, suitable lignocellulose derived carbons, are contemplated herein. In some embodiments, it may be desirable to use a mixtures of carbon particles to achieve a desired particle and pore size distribution. For example, wood based carbons, which are predominantly mesoporous (between 2 and 50 nm in size) and coconut carbons, which are predominantly microporous (less than 2 nm in size ), may be mixed together.

The activated carbon particles may be uncoated or coated. When coated filter particles are used, preferably at least a portion of the filter particles is coated with a material selected from the group consisting of silver, a silver-containing material, a cationic polymer, and mixtures thereof. Preferred cationic polymers for use in the present invention are selected from the group consisting of: poly(N-methylvinylamine), polyallylamine, polyallyldimethylamine, polydiallylmethylamine, polydiallyldimethylammonium chloride, polyvinylpyridinium chloride, poly(2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethyaminoethylmethacrylate), polyethyleneimine, polylysine, DAB-Am and PAMAM dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, grafted starch, the product of alkylation of polyethyleneimine by methylchloride, the product of alkylation of polyaminoamides with epichlorohydrine, cationic polyacrylamide with cationic monomers, dimethyl aminoethyl acrylate methyl chloride (AETAC), dimethyl aminoethyl methacrylate methyl chloride (METAC), acrylamidopropyl trimethyl ammonium chloride (APTAC), methacryl amodopropyl trimethyl ammonium chloride (MAPTAC), diallyl dimethyl ammonium chloride (DADMAC), ionenes, silanes and mixtures thereof. Preferably the cationic polymers are selected from the group consisting of: polyaminoamides, polyethyleneimine, polyvinylamine, polydiallyldimethylammonium chloride, polydimethylamine-epichlorohydrin, polyhexamethylenebiguanide, poly-[2-(2-ethoxy)-ethoxyethlyl-guanidinium]chloride.

Additionally, the carbon filters may comprise organic binders, inorganic binders, or combinations thereof. One example of a suitable binder is a polyethylene binder. Moreover, although the carbon block filter is effective for removal of all types of fluid contaminants, it may be desirable to utilize an additional heavy metal removal composition. For, example, amorphous titanium silicate (ATS) is highly effective as a lead adsorbent. Other suitable heavy metal removal components are contemplated herein. It is also contemplated to use additional components, such as ion exchange resins, additional sorbents, or combinations thereof.

Various compositional amounts are contemplated for the carbon filter. In specific embodiments, the carbon filter may comprise from about 25% to about 49% by weight coconut carbon, from about 35% to about 45% by weight pDADMAC coated wood-based carbon, from about 10% to about 20% by weight polyethylene binder, and from about 2% to about 10% by weight amorphous titanium silicate. The pDADMAC may comprise from about 1% to about 4% by weight, or about 2% by weight, of the pDADMAC coated wood-based carbon. The pDADMAC is coated onto the wood-based carbon prior to mixing and block formation of the carbon block filter 2. The coating may be applied via a spray coating/drying operation, or another suitable coating process familiar to one of ordinary skill in the art.

The pDADMAC coated carbon is desirable because it yields improved filtration of microorganisms from drinking water. In an exemplary embodiment, the coated wood based carbon demonstrates a mesopore volume from about 0.5 to about 0.7 ml/gm, and a total pore volume from about 1 to about 1.5 ml/gm. Moreover, in one exemplary embodiment, the wood based carbon may include mesopores having a pore diameter from about 2 to about 50 nm, a particle size of about 30μ diameter, and a span from about 1 to about 1.6, or from about 1.3 to about 1.4. As used herein, the term “mesopore” is intended to refer to an intra-particle pore having a width or diameter between 2 nm and 50 nm (or equivalently, between 20 Å and 500 Å). As used herein, the phrase “mesopore volume” refers to the volume of all mesopores.

As used herein, the phrase “median particle size” refers to the diameter of a particle below or above which 50% of the total volume of particles lies. This median particle size is designated as D_{v,0.50}. While many methods and machines are known to those skilled in the art for fractionating particles into discreet sizes, sieving is one of the easiest, least expensive and common ways to measure particle sizes and particle size distributions. An alternative preferred method for determining size distribution of particles is with light scattering. Further, the phrase, “particle span” is a statistical representation of a given particle sample and can be calculated as follows. First, the median particle size, D_{v,0.50}, is calculated as described above. Then by a similar method, the particle size that separates the particle sample at the 10% by volume fraction, D_{v,0.10}, is determined, and then the particle size that separates the particle sample at the 90% by volume fraction, D_{v,0.90}, is determined. The particle span is then equal to: (D_{v,0.90}−D_{v,0.10})/D_{v,0.50}.

In one exemplary embodiment, the carbon filter may comprise activated carbon filter particles having a median particle size of less than about 50 μm, less than about 40 μm, less than about 37.5 μm, and less than about 35 μm. Moreover, the filter particles may have a particle span from about 1.8 or less, about 1.5 or less, about 1.4 or less, and about 1.3 or less.

The fiber composite filter, which may optionally be present as a pre-filter or post-filter, may comprise electropositive metallic fibers having dimensions of between 5 nm and 100 nm. As described below, the electropositive metallic fibers may comprise aluminum components selected from the group consisting of alumina, aluminum hydroxide, boehmite, or combinations thereof. It is contemplated that other electropositive metallic fibers may also be used.

The fiber composite filter may include alumina distributed on a glass fiber scaffolding, which thereby forms an alumina based composite filter. In operation, the alumina based composite filter is highly electropositive. Due to this positive charge, the alumina fibers attach to and remove negatively charged material from an influent fluid. The alumina based composite filter is configured to remove any type of negatively charged contaminant from fluids, for example, heavy metals such as colloidal lead. In one exemplary embodiment, the fiber composite filter may remove humic acid from the influent water. For example, as the influent water passes through the fiber composite filter, this filter removes substantially all the humic acid from the influent water. Consequently, since a substantial amount of the humic acid has been removed from the influent water, the activated carbon filter, which is downstream of the fiber composite filter, can more effectively remove heavy metals and microorganisms. It is understood that the water filter configuration, composition, and structure may be modified to adjust the level of humic acid, heavy metal, and/or microorganism removal that may be achieved by the fiber composite filter, the activated carbon filter, or the combination thereof.

An exemplary alumina based composite filter is commercially available from the Argonide Corporation, and has the product name NanoCeram®. NanoCeram® is a composite material comprising alumina (e.g., boehmite) fibers having a size less than 100 nm attached to glass fibers. Cellulose and polymeric fibers may be added to strengthen the media and increase its flexibility. The alumina based composite filter may be a separate and distinct filter from the activated carbon filter or integral with the activated carbon filter. In one exemplary embodiment, activated carbon filter particles may be embedded into the alumina based composite filter.

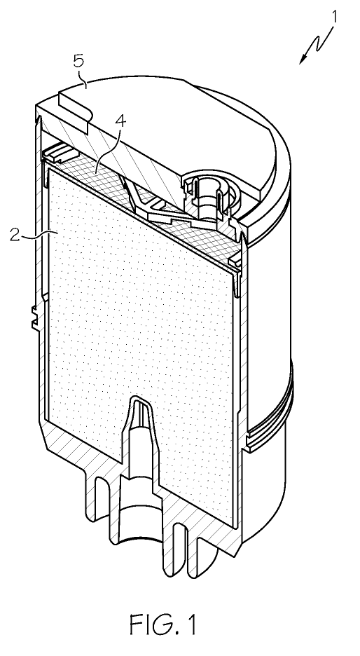

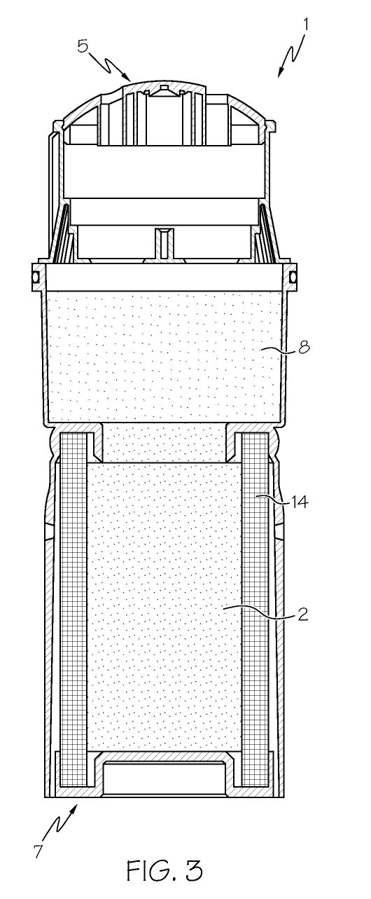

FIGS. 1-4 provide various filter structure embodiments in accordance with the present invention. As shown in FIG. 1, the filter 1 may include a housing 5 with a carbon filter 2 and a pre-filter disk 4 upstream of the carbon filter 2. While the pre-filter disk of FIG. 1 may include a fiber composite (e.g., an alumina based composite filter), it is contemplated that the pre-filter disk 4 may include other filter types for example, a carbon based filter. Referring to FIG. 3, the filter 1 may include a bed 8 of loose carbon particles upstream of the carbon filter 2. In alternative embodiments, the pre-filter may be a filter block (not shown) comprising carbon particles and a binder. In yet another embodiment, the pre-filter may also comprise a multi-tier structure comprising at least one fiber composite filter, and at least one layer of a carbon filter. Alternatively, the water filter 1 may comprise, not only the alumina based composite filter 4 upstream of the carbon filter block 2 as shown in FIG. 1, but also a second alumina based composite filter (not shown) positioned upstream or downstream of the carbon filter block 2.

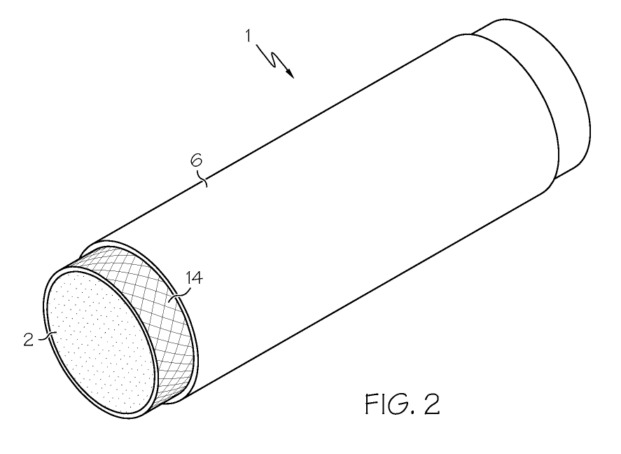

Referring to the alternative embodiment of FIG. 2, a filter 1 may comprise an activated carbon filter block 2 and a pre-filter wrap 14 comprised of the filter composite material (e.g., the alumina based composite material) and disposed on the carbon filter block 2. Like the disk 4 of FIG. 1, the pre-filter wrap 14 of FIG. 2 may also include a carbon based filter as an alternative to the fiber composite. While various shapes are contemplated, the pre-filter wrap may be a pleated filter wrap.

Further as shown in FIG. 2, the filter 1 may also include a sediment filter wrap 6 over the pre-filter wrap 14, for example, on the outer surface of the pre-filter wrap 14. It is also contemplated to place the sediment wrap on other surfaces of the alumina based pre-filter wrap 14, the carbon block filter 2, or combinations thereof. The sediment filter wrap 6 may comprise glass media, fabrics, or suitable polymeric materials. The sediment filter wrap 6 may by the Lypore® glass media produced by Lydall Corporation. In operation, the sediment wrap 6 may help protect the filter media (e.g., alumina based pre-filter 4 and/or carbon block filter 2) from sediment in the water. The sediment filter wrap 6 operates by sieving sediment particulates, but it is contemplated that it could also utilize adsorbent components therein. Similar to the pre-filtered embodiment of FIG. 1, the water filter 1 of FIG. 2 is configured to filter an influent stream through the alumina based composite pre-filter wrap 14 prior to filtering the fluid in the carbon block filter 2.

FIG. 3, like FIG. 2, is directed to a pre-filter wrapped carbon filter comprising a carbon filter block 2 and a filter wrap 14 (for example, a fiber composite filter wrap) disposed upstream of the carbon filter block 2. Further as shown in FIG. 3, the filter 1 may include another carbon filter 8 disposed upstream of the pre-filter 14 and the carbon filter 2. In one exemplary embodiment, the upstream carbon filter 8 may be a loose bed of carbon particles; however, carbon blocks or other filter structures are contemplated herein. In operation, an influent stream may sequentially enter the carbon filter 8, and then the pre-filter wrap 14 and the carbon block filter 2.

Optionally, the filter 1 of FIGS. 1 through 3 may also comprise a flow regulator (not shown) disposed adjacent an outlet of the filter. The flow regulator acts as a flow restrictor which limits fluid flow within the filter housing 5 to about 2 L/min to about 3 L/min, or about 2.5 L/min. By restricting the flow, the filter ensures that the fluid has sufficient residence time inside the filter for contaminant removal. One suitable commercial flow regulator is the MRO3 Type Flow Regulator produced by Neoperl GMBH.

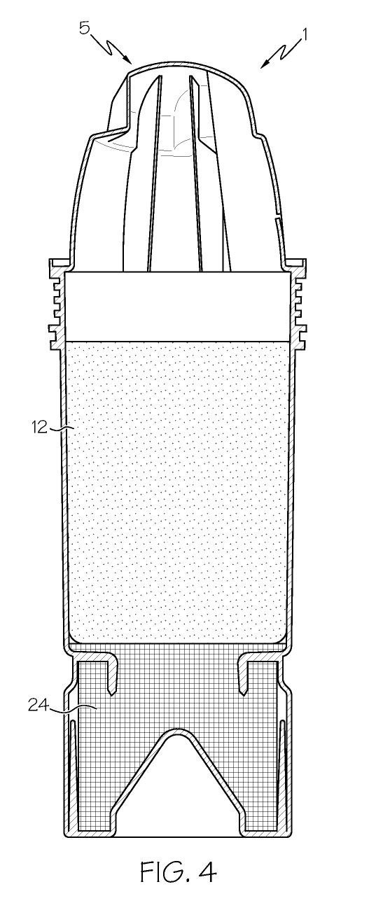

Referring to the embodiment of FIG. 4, the filter 1, which is a gravity fed filter for pitcher or carafe embodiments, includes a carbon filter 12 (for example, a loose bed carbon filter) and a downstream fiber composite filter 24. Like above, it is contemplated to use a carbon filter instead of the downstream fiber composite filter. Also, it is contemplated to use an additional pre-filter upstream of the carbon filter 12, or an additional post-filter downstream of the carbon filter 12, the fiber composite filter 24, or both.

To demonstrate the effects of multi-stage filters as described above, the following experimental examples, as listed in Table 1 and described below, are provided. The following experimental examples are comparative examples demonstrating the total organic carbon (TOC) removal for various pre-filter embodiments.

TABLE 1

| | Example 1 | | Example 2 | | Example 3 | | Example 4 | | Example 5 | |
|---|---|---|---|---|---|---|---|---|---|---|
| Aliquot | Adsorp. | | Adsorp. | | Adsorp. | | Adsorp. | | Adsorp. | |
| Sample | @ 300 nm | TOC | @ 300 nm | TOC | @ 300 nm | TOC | @ 300 nm | TOC | @ 300 nm | TOC |
| 1 | 0.204 | 4.44 | 0.195 | 1.014 | 0.008 | 5.75 | 0.181 | 4.32 | 0.179 | 3.13 |
| 2 | 0.356 | 3.10 | 0.365 | 0.533 | 0.04 | 5.65 | 0.383 | 2.65 | 0.336 | 1.91 |
| 3 | 0.413 | 2.40 | 0.422 | 0.489 | 0.081 | 5.27 | 0.47 | 1.85 | 0.401 | 1.43 |
| 4 | 0.456 | 2.17 | 0.468 | 0.410 | 0.127 | 4.76 | 0.529 | 1.28 | 0.441 | 1.09 |
| 5 | 0.491 | 1.79 | 0.485 | 0.387 | 0.18 | 4.30 | 0.559 | 1.09 | 0.464 | 0.90 |
| 6 | 0.52 | 1.56 | 0.511 | 0.412 | 0.207 | 4.02 | 0.57 | 0.86 | 0.475 | 0.82 |
| 7 | — | — | 0.519 | 0.360 | — | — | — | — | — | — |
| Total | | 15.46 | | 3.606 | | 29.74 | | 12.06 | | 9.28 |
| ppm | | | | | | | | | | |

### EXAMPLE 1

### Carbon/Binder Pre-Filter Block

The pre-filter of Example 1 was a pre-filter carbon block comprising wood based carbon without a coating and comprising a 1 inch height. The pre-filter carbon block comprises 20% binder and 80% uncoated Nuchar® RGC (80×325) manufactured by Mead WestVaco. To test the total organic carbon (TOC) removal, 3 liters total of EPA-3 Humic Acid water was delivered to the pre-filter using (6) six aliquots, wherein each aliquot comprises 12 ppm of Humic Acid, or 6 mg of Humic Acid per 500 ml aliquot. Each 500 ml aliquots are delivered at a flow rate of 2 L/min. The TOC removal was measured by adsorption at 300 nm using a spectrophotometer, wherein the output signals from the spectrophotometer was plotted on a calibration curve to yield the TOC value. The TOC removal, which was measured with a spectrophotometer, yielded a removal of 15.46.

### EXAMPLE 2

### Nanoalumina Pre-Filter

The pre-filter of Example 2 was the Nanoceram® nanoalumina pre-filter produced by Ahlstrom. The pre-filter, which comprised a 2.25 inch diameter, was supported using a Gelman Science filter holder. To test the total organic carbon (TOC) removal, 3 liters total of EPA-3 Humic Acid water (10 ppm TOC) was delivered to the pre-filter using (7) seven aliquots, wherein each aliquot included 500 ml aliquots delivered at a flow rate of 2 L/min. The TOC removal, which was measured with a spectrophotometer, yielded a removal of 3.606.

### EXAMPLE 3

### Loose Bed Carbon Pre-Filter (27 g)

The pre-filter of Example 3 was an uncoated loose bed uncoated wood base carbon weighing 27 g. The pre-filter comprises uncoated Nuchar® RGC (80×325) carbon manufactured by Mead WestVaco disposed in a 1.86 inch diameter filter housing. Like above, 3 liters total of EPA-3 Humic Acid water (12 ppm TOC) was delivered to the pre-filter using (6) six aliquots, wherein each aliquot included 500 ml aliquots delivered at a flow rate of 2 L/min. Like above, TOC removal was measured using a spectrophotometer. In this example, the 27 grams of carbon yielded a removal of 29.74 ppm of TOC.

### EXAMPLE 4

### Loose Bed Carbon Pre-Filter (13 g)

The pre-filter of Example 4 was an uncoated loose bed uncoated wood base carbon weighing 13 g. The pre-filter comprises uncoated Nuchar® RGC (20×50) carbon manufactured by Mead WestVaco in a 2.14 inch diameter filter housing. To test the total organic carbon (TOC) removal, 3 liters total of EPA-3 Humic Acid water (12 ppm TOC) was delivered to the pre-filter using (6) six aliquots, wherein each aliquot included 500 ml aliquots delivered at a flow rate of 2 L/min. As shown above, the total TOC removal, as calculated using a spectrophotometer, was 12.06 ppm of TOC removed by the media.

### EXAMPLE 5

### Carbon and Nanoalumina Two Tier Pre-Filter

The pre-filter of Example 5 was a two tier pre-filter combining carbon and filter media. The top tier comprised 10 g of uncoated RGC (80×325) carbon in a 2.14 inch diameter filter housing (bed height is 0.6785 inches) and the bottom tier comprises nanoalumina on glass fibers. To test the total organic carbon (TOC) removal, 3 liters total of EPA-3 Humic Acid water (9.15) was delivered to the pre-filter using (6) six aliquots, wherein each aliquot included 500 ml aliquots delivered at a flow rate of 2 L/min. As shown above, the total TOC removal was 9.28 ppm of TOC removed by the media.

The following experimental examples listed in Table 2 provide additional examples of pre-filters comprising multiple layers and combinations of different filter media compositions.

TABLE 2

| | | TOC |
|---|---|---|
| | | removed |
| Filter compositions | Volume | (ppm) |
| Single layer of Ahlstrom 9630 media | 633 gm | 5.76 |
| 1 layer of Nanoceram + 1 layer of plastic foam | 907 gm | 7.1 |
| 1 layer of Nanoceram + 2 layers of microglass | 1999 gm | 13.7 |
| 2 layers of Nanoceram + 3 layers of microglass | 2996 gm | 20.36 |

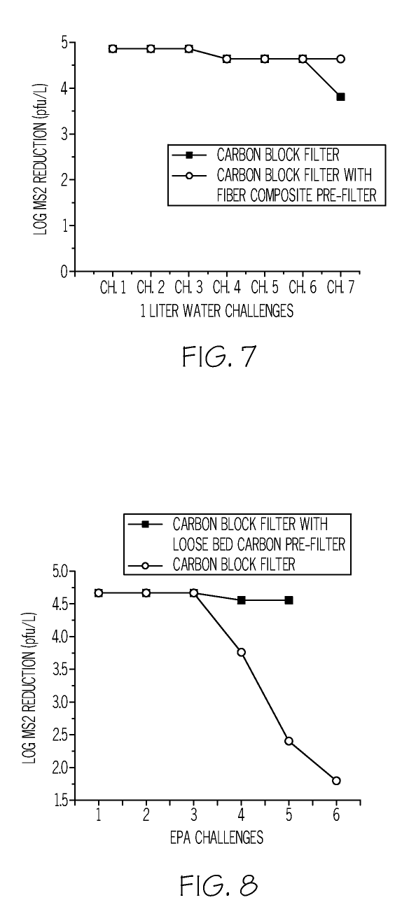

FIGS. 7 and 8 are two graphical illustrations which compare the performance of filters with pre-filter components to non-prefiltered components. As shown in FIG. 7, the carbon block filter without the fiber composite pre-filter fails at the 7th EPA challenge or (1 liter challenge) whereas the filter with the fiber composite pre-filter is still effective at the 7th EPA challenge or (1 liter challenge). Each challenge involves exposing the filter to a 1 liter influent solution wherein humic acid levels are roughly 37 mg/L, bacteria is present at about roughly 500,000,000 coliform units per liter (cfu/L), and the virus surrogate MS2 is present at about 50,000,000 plague forming units per liter (pfu/L). As would be familiar to one of ordinary skill in the art, the EPA may set minimum removal levels for contaminants depending on the contaminant removed and other factors. In the graphical illustrations of FIGS. 7 ands 8, failing the EPA challenge means that the filter has a log MS2 reduction of less than about 4. As shown in FIG. 8, the filter without the coated granular carbon pre-filter failed in the 4th challenge while the pre-filtered filter passed the 4^{th} and 5^{th} challenges.

It is further noted that terms like “preferably,” “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is additionally noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water filter comprising:
at least one carbon filter comprising activated carbon particles; and
at least one fiber composite filter comprising electropositive metallic fibers having dimensions of between 5 nm and 100 nm, wherein the fiber composite filter is disposed upstream of the carbon filter, downstream of the carbon filter, or both.

2. The water filter of claim 1 wherein the electropositive metallic fibers comprise aluminum components selected from the group consisting of alumina, aluminum hydroxide, boehmite, or combinations thereof.

3. The water filter of claim 1 further comprising a filter housing surrounding the carbon filter, the fiber composite filter, or both.

4. The water filter of claim 3 wherein the aluminum components are disposed on or enmeshed in glass fibers.

5. The water filter of claim 1 wherein the fiber composite filter is a disk, a filter wrap, or combinations thereof.

6. The water filter of claim 1 wherein the filter wrap is pleated.

7. The water filter of claim 1 wherein the carbon filter is a compressed block comprising a binder.

8. The water filter of claim 1 wherein the carbon filter is a bed of loose carbon particles without a binder.

9. The water filter of claim 1 wherein the activated carbon particles are selected from the group consisting of wood-based carbon, coconut carbon, or combinations thereof.

10. The water filter of claim 1 wherein the activated carbon particles are coated with a cationic polymer.

11. The water filter of claim 1 wherein the activated carbon particles comprise a median particle size less than 50 μm, and a particle span of less than 1.8.

12. The water filter of claim 1 wherein the carbon filter comprises titanium silicate.

13. A method of producing potable water comprising:
providing the filter of claim 1; and
producing potable water by delivering a fluid stream to the filter to produce potable water.

14. A water filter comprising:
a first carbon filter comprising activated carbon particles; and
a second carbon filter disposed upstream of the first carbon filter, downstream of the first carbon filter, or combinations thereof.

15. The water filter of claim 14 further comprising a fiber composite filter disposed upstream of the first carbon filter and comprising electropositive metallic fibers having dimensions of between 5 nm and 100 nm,

16. The water filter of claim 14 wherein the second carbon filter is a loose bed of particles without a binder, and the first carbon filter is an activated carbon block filter.

17. The water filter of claim 14 wherein the first carbon filter, the second carbon filter, or both include coated activated carbon particles.

18. The water filter of claim 14 wherein the second carbon filter is a disk, a filter wrap, or combinations thereof.

19. A method of producing potable water comprising:
providing the filter of claim 14; and
producing potable water by delivering a fluid stream to the filter to produce potable water.
